(19) United States
(12) Patent Application Publication
(10) Pub. No.: US 2007/0100611 A1
(43) Pub. Date: May 3, 2007

(54) Speech codec apparatus with spike reduction

(75) Inventors: RamKumar PS, Bangalore (IN); Raghavendra Sagar, Bangalore (IN); Karthik Kannan, Bangalore (IN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Intel Corporation

(21) Appl. No.: 11/322,962

(22) Filed: Dec. 30, 2005

(30) Foreign Application Priority Data
Oct. 27, 2005 (IN) 2881/DEL/2005

(51) Int. Cl. G10L 21/00

(52) U.S. Cl. 704/213

(57) ABSTRACT

A method and an apparatus are disclosed to reduce spikes present in speech signals of a VOP (Voice over Packet) communication system. The apparatus receives speech signals, detect spikes if present in the speech signals and filters the spikes in the speech signals so as to communicate speech signals having reduced spikes to the users of the communication systems.

### BACKGROUND OF THE INVENTION

In a voice over packet (VOP) communication system, distortion and/or interferences for example radio frequency (RF) interference, acoustic interference, power line interference and channel distortion may be introduced at various stages during communication of voice signals. These interferences may some time be temporal spikes of very short duration and manifest as an audible disturbance to the listeners.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates a block diagram of a spike detection unit

FIGS. 2-5 illustrates different kinds of spikes

FIG. 6 illustrates an embodiment of a speech codec apparatus

FIG. 7 illustrates an embodiment of an interference excision unit

FIG. 8 illustrates another embodiment of an interference excision unit

FIG. 9 illustrates an embodiment of a spike removal process that may be implemented by the system of FIG. 1.

### DETAILED DESCRIPTION OF THE INVENTION

In the following detailed description, numerous specific details are described in order to provide a thorough understanding of the invention. However the present invention may be practiced without these specific details. In other stances, well known methods, procedures, components and circuits have not been described in detail so as not to obscure the present invention. Further, example sizes/models/values/ranges may be given, although the present invention is not limited to these specific examples.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic.

Moreover, such phrases are not necessarily referring to the same embodiment.

Further, when a particular feature, structure, or characteristic is described in connection with an embodiment, it is submitted that it is within the knowledge of one skilled in the art to affect such feature, structure, or characteristic in connection with other embodiments whether or not explicitly described.

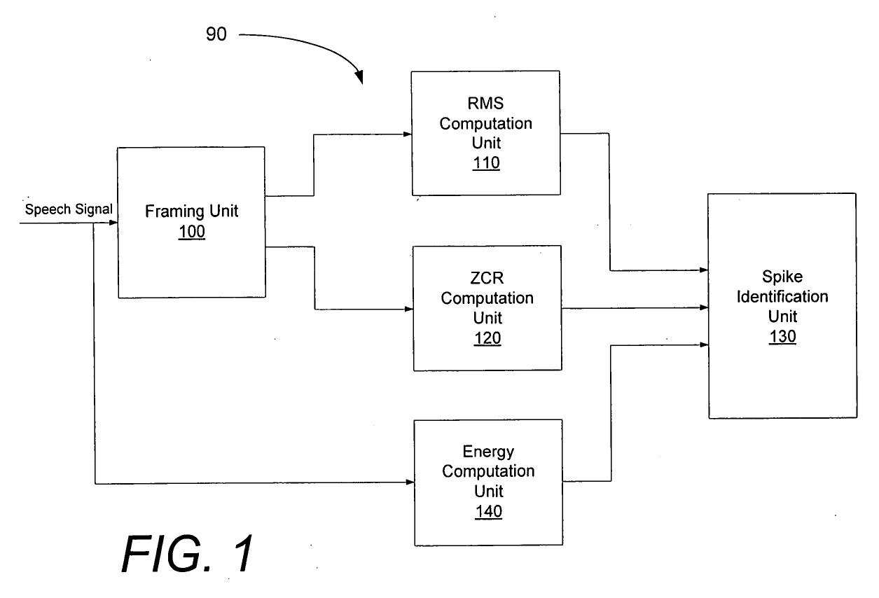

Referring now to FIG. 1, an embodiment of a spike detection unit 90 is shown. The spike detection unit 90 may include a framing unit 100, a RMS (Root Mean Square) computation unit 110, a ZCR (Zero Crossing Rate) computation unit 120, a spike identification unit 130 and an energy computation unit 140.

The framing unit 100 may receive the speech signal data and may allocate the speech signals into frames for processing. According to an embodiment, the framing unit 100 may overlap frames such that a set of speech data may be allocated to more than one adjoining frames. Thus for example a first frame of speech data may include speech data sampled at time 1 to time 10, a second frame of speech data may include speech data sampled from time 6 to time 15, and a third frame of speech data may include speech data sampled from time 11 to time 20. It should be appreciated that other framing techniques may be utilized by the framing unit 100.

The RMS computation unit 110, according to an embodiment, may compute a RMS value for each frame of speech data received from the framing unit 100. The RMS value measures the strength of the signal in each frame. A high RMS value indicates a high-energy signal frame. According to an embodiment of the RMS computation unit 110, the RMS value for a frame i may be computed as:

$${RMS}_{i} = k * \sqrt{( 1 / N ) \{ {\sum }_{n = 0}^{N - 1} {x}_{i}^{2} ( n ) \}}$$

where N is number of samples in a frame, RMSᵢ is the RMS value of the i^{th} frame, xᵢ(n) is the n^{th} speech sample in i^{th} frame, and k is a constant.

The ZCR computation unit 120, according to an embodiment, may compute a ZCR value for each frame of speech data received from the framing unit 100. The ZCR value measures the rate at which a speech signal switches across its mean value for the frame. Noisy signals are random in nature and typically have a high ZCR value. Speech signals characterized by quasi-periodicity typically have lower ZCR and change very slowly with time. The ZCR computation unit 120 generates a ZCR value that is normalized by its frame width. ZCRᵢ is the ZCR value of frame i in the speech data.

The spike identification unit 130 according to an embodiment may detect presence of type X spikes as described and illustrated with reference to FIG. 4.

In this embodiment, the spike identification unit 130 may determine the presence of type X spikes in a frame of speech data when the RMS value in the frame is greater than a first predetermined value and the ZCR value in the frame is less than a second predetermined value. The predetermined values may be set such that type X spikes are determined when a high RMS value and a low ZCR value are present.

The spike identification unit 130 may detect presence of type Z and/or type Y spikes as described and illustrated with reference to FIGS. 3 and 5. In this embodiment, the spike identification unit 130 determines the presence of type Z and/or type Y spikes in a frame of speech data when the RMS value in the frame is greater than a third predetermined value and the ZCR value in the frame is greater than a fourth predetermined value. The predetermined values may be set such that type Y and/or type Z spikes are determined when a high ZCR value and a medium to high RMS value are present.

The spike identification unit 130 may also detect the presence of Y and/or type Z spikes in a frame of speech data by evaluating the RMS values of the frame and the RMS values of its neighboring frames. In one embodiment, the spike identification unit 130 may detect a presence of Y and/or type Z spikes in a frame n of speech data when a difference in a RMS value for the frame n and a RMS value for a frame n−2 is greater than a fifth predetermined value, a difference in the RMS value for the frame n and a RMS value for the frame n+2 is more than a sixth predetermined value, and a difference in RMS values for frames n−4 and n−2 and a difference in RMS values for frames n+4 and n+2 are less than a seventh predetermined value. The type of Y and/or Z type spikes that satisfy these conditions may be large spikes present in pure speech or background noise that is noticeable to the human ear.

The energy computation unit 140 according to an embodiment may compute a sample energy value of a speech sample received. According to an embodiment, the energy computation unit 140 may compute a Teager sample energy value using the Teager energy operator. In particular, the Teager energy operator may be described as:
ψ(n)=x²(n)−x(n−1)*x(n+1)
where ψ(n) is a Teager sample energy of speech sample x(n).

The Teager energy operator may generate a Teager sample energy value that emphasizes fast variations and deemphasizes slow variations in speech signal amplitude. Teager sample energy values will indicate sharp rises/falls when speech samples vary significantly in amplitude with respect to adjacent samples. The presence of sharp rises/falls in Teager sample energy values indicates a probable presence of a spike. It should be appreciated that other energy operators may also be used by the energy computation unit 140.

The spike identification unit 130 may evaluate sample energy value generated for a speech sample at a position q with respect to sample energy values of neighboring speech samples. If any of the neighboring sample energy values is less than the sample energy value at position q by a ninth predetermined value, the spike detection unit 140 may determine that a spike is present. According to an embodiment of the present invention, exemplary positions of neighboring speech samples may be at positions q−2, q−1, q+1, and q+2, and an exemplary ninth predetermined value is 0.35. In addition to detecting the presence of an impulsive distortion in speech data, the spike detection unit 140 may also generate an indication as to a relative position of the impulsive distortion.

According to an embodiment, the spike identification unit 130 and the energy computation unit 140 may operate such that the energy computation unit 140 computes sample energy values for speech data where type X, Y, and/or Z spikes are not detected. In this embodiment, the spike detection unit 140 may forward information regarding speech data where X, Y, and/or Z spikes have been detected to the energy computation unit 140.

The predetermined values described with reference to FIG. 1 may have been described with reference to an order, one to nine. It should be appreciated that the order need not correspond to the magnitude of the value. It should also be appreciated that predetermined values having a different order may have the same value.

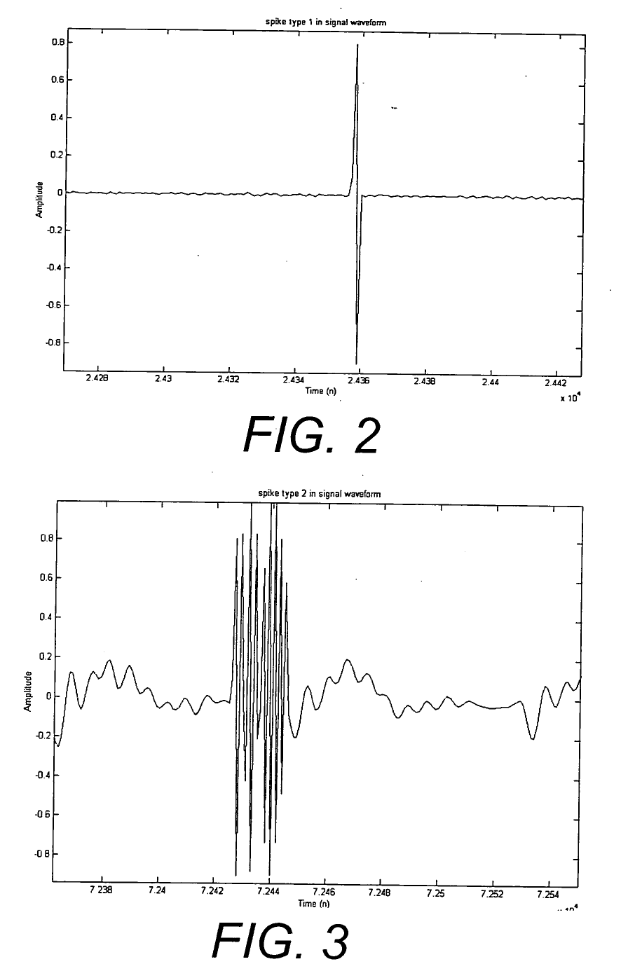

Referring now to FIGS. 2-5, different kinds of spikes are shown. As depicted in FIG. 2, a waveform may have a signal of high amplitude but for a very short time and known as type W-spikes. As shown FIG. 3, a waveform may consist of signals of medium to high RMS (root mean square) and high ZCR (zero crossing rates). These signals may be due to unexpected tone content and known as type Z-spikes. As depicted in FIG. 4, a waveform may have signals of low ZCR and high RMS in the form of a bell but not for a long time and known as type X-spikes. Similarly and as shown in FIG. 5, a waveform may have signals of high energy Gaussian noise but for a short duration and known as type Y-spikes. These signals may be characterized by high ZCR and medium to high RMS.

The signals may be identified on the basis of the characteristics of speech data frames of the neighboring waveforms. If the neighboring waveforms are of the uniform amplitude and suddenly an abnormal signal or a signal of high amplitude occurs, it may be treated as the spike. To identify such type of spikes continuous monitoring of the frames of the waveforms may be required and if some abnormal signal appears suddenly in a frame it may be detected and even that particular waveform frame may be identified. Thus the presence and position of the spikes may be determined. These spikes may be filtered in the manner as described herein.

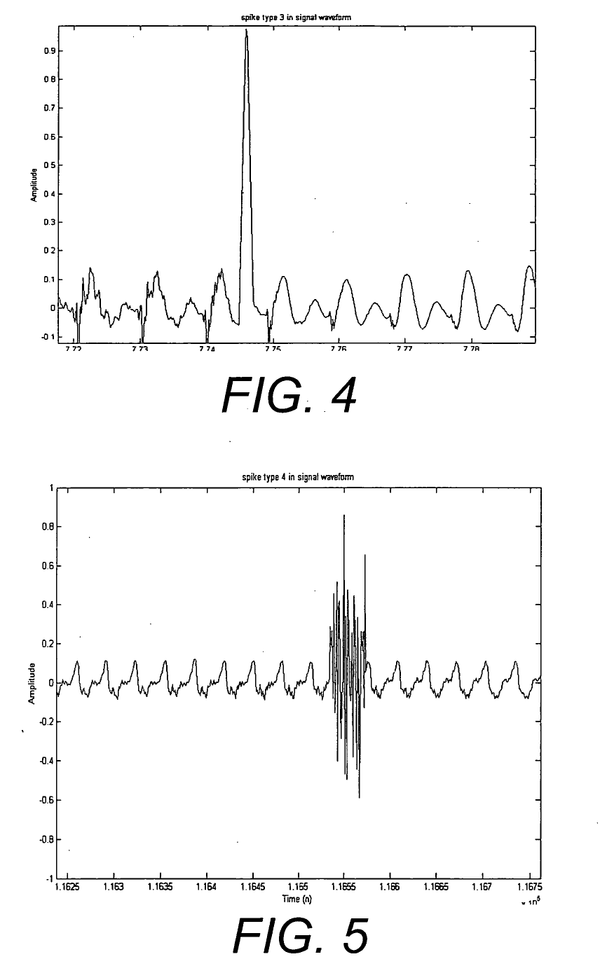

Referring to FIG. 6, an embodiment of a speech codec apparatus is shown. The speech codec apparatus may comprise a voice channel 1 at one end of the communication network and voice channel 2 at the other end of the communication system. The voice channel 1 and 2 may function as a transmitter unit and/or a receiver unit in order to transmit and receive speech signals to complete the communication at both the ends of the communication system. As depicted, the voice channel 1 and/or voice channel 2 according to an embodiment may include a telephony interface 200, an enhanced encoder 300 and an enhanced decoder 400.

As depicted the telephony interface 200 may be coupled to an interference excision unit (IEU) 305 of the enhanced encoder 300 so as to transmit speech signals from a telephone device (not shown) of a user to the IEU 305 of the enhanced encoder 300. The telephony interface 200 may also be coupled to an IEU 405 of the enhanced decoder 400 so as to receive speech signals from the IEU 405 of the enhanced decoder 400 and communicate the speech signals to the user of the communication system.

As depicted the telephony interface 200 may receive speech signals from a telephone device of the user and convey the speech signals to the IEU 305 of the enhanced encoder 300. The IEU 305 may receive the speech signals and detect presence and position of spikes, if any, present in the speech signals. The IEU 305 may filter the speech signals to provide speech signals having reduced spikes to a speech encoder 310 such as, for example, a Global System for Mobile (GSM) Adaptive Multi-Rate (AMR) voice encoder of the voice channel 1. The speech encoder 310 may encode the speech signals with reduced spikes and may convey the compressed/encoded speech signals packet (Pkt) to the destination through a conventional network.

The speech decoder 410, such as a GSM/AMR voice decoder, of the voice channel 2 provided at the other end of for example wire and/or wireless network may receive the compressed or encoded speech signals packet and convey decoded speech signals to the IEU 405. The IEU 405 may detect the presence and position of spikes and may reduce the spikes from the speech signals by filtering the speech signals. The speech signals with reduced spikes may be conveyed to the telephony interface 200 of the voice channel 2 which may be transmitted to a person through the network and an intended phone instrument.

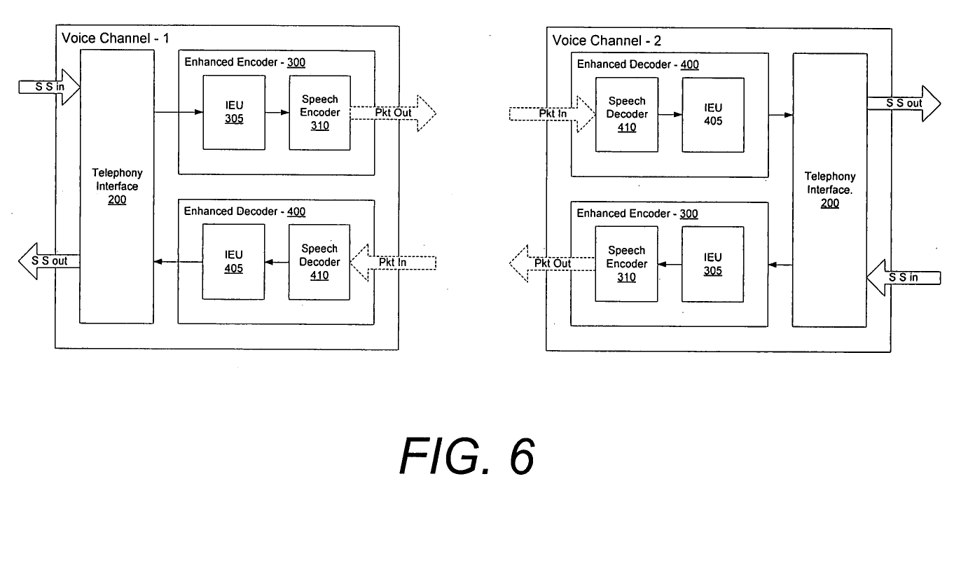

Referring now to FIG. 7, an embodiment of the interface excision unit (IEU) 305 is shown. The IEU 305 may comprise an interface 306, a processor 307 and a memory 308. The interface 306 may facilitate receiving speech signals transmitted by a telephony interface 200, speech encoder 310 and/or speech decoder 410 and convey the speech signals to a processor 307. The processor 307 may process the speech signals so as to detect presence of the spikes and positions of the spikes in the speech signals in a manner similar to the spike detection unit 90 of FIG. 1.

In one embodiment, the processor 307 may further filter frames of the speech signal that are associated with detected spikes. For example, the processor 307 may use a simple interpolator based on the immediate neighboring samples of the data frames to filter the spikes. If for example frame i may be identified as a spiky frame, here let N be frame size and Xᵢ may be i^{th} frame of the speech signal X. Then Xᵢ(0 . . . N−1) may be identified as a spiky signal. In particular, spike filtered signal Yᵢ may be
Yᵢ(n)=k*{[Xᵢ₋ₗ(n)+Xᵢ₊ₗ(n)]/2}, 0≦n≦N−1
where k≦1 is the loss factor.

This method may be based on the principle that the properties of the speech do not vary rapidly with time due to inherent redundant information present in the speech signals. The spikes occurring in the speech may be of very short duration thus permitting averaging the neighboring/adjoining frames on the either side of the spiky frame as the filtered frame. The processor 307 used to filter the spikes in one embodiment may for example comprise an Intel Pentium Processor.

The processor 307 may detect the position of the spikes in the speech signals and filter the speech signals so as to reconstruct speech signals and/or regenerate speech signals data frames with reduced spikes by interpolating speech signals from neighboring frames. In one embodiment the processor 307 may filter a speech data frame with at least one detected spike based upon speech data of a preceding frame and speech data of a succeeding frame. In another embodiment filtering may for example, comprise replacing the identified frame with a replacement frame generated by averaging neighboring frames of the identified frame to reduce spikes in the replacement frame.

Detection and filtering of the speech signals may be done before encoding and transmitting the speech signals at the transmitter side of the communication network. If the spikes are not removed before encoding, the encoding algorithm used in the speech codec may spread the effects of the spikes into the neighboring speech signal samples and thus distort the quality of the speech.

Similarly detection of the spikes and filtering of the spikes from the speech signals may be done after receiving and decoding the speech signals by the speech decoder 410 provided at the other end of the network that is receiver side of the network. The spikes may be detected and filtered by the processor 307 in a similar manner as described herein above so as to transmit speech signals having reduced spikes to the user on his instrument. In one embodiment, if spikes are not found in the speech signals, then the speech signals may be conveyed to the encoder 310 or decoder 410 without going through filtering process in the respective processors 307.

As depicted the memory 308 may be used to store data and instructions of the processor during detection and filtering of the spikes. The memory 308 may comprise for example RAM (Random Access Memory) devices such as source synchronous RAM devices and DDR (Double Data Rate) RAM devices.

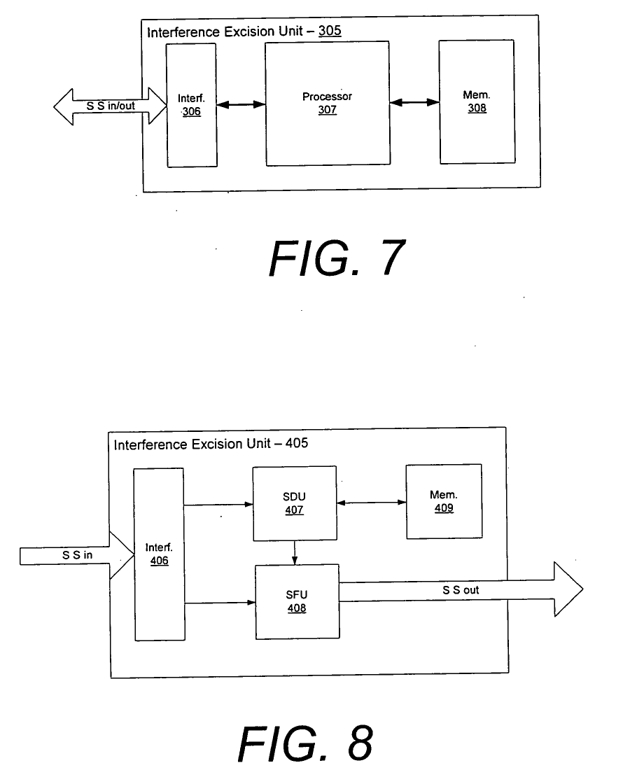

Referring now to FIG. 8, another embodiment of the interface excision unit 405 is shown. The IEU 405 may comprise an interface 406 to facilitate receiving the speech signals from the encoder 310 or the decoder 410 and convey the signals to a spike detection unit (SDU) 408. The spike detection unit 408 may be coupled with the interface 406. A spike filtration unit (SFU) 408 may be coupled with the interface 406 and also with the SDU 408. The SDU 408 may receive the speech signals and detect the presence and position of spikes in the speech signals in a manner similar to the speech detection unit 90 of FIG. 1.

The speech signals having the spikes may be transmitted to the SFU 410 to filter the spikes. The SFU 410 may filter the spikes from the speech signals on the principal for example of interpolation. In one embodiment SFU 410 may for example use a simple interpolator based on the immediate neighboring samples of the data points to filter spikes. If for example frame i may be identified as a spiky frame, let N be frame size and Xi be i^{th} frame of the speech signal X, then Xᵢ(0 . . . N−1) may be identified as a spiky signal frame. These spiky signals frames may then be filtered to regenerate the frames having reduced spikes. In particular, spike filtered signal Yᵢ may be
Yᵢ(n)=k*{[Xᵢ₋ₗ(n)+Xᵢ₊ₗ(n)]/2}, 0≦n≦N−1
where k≦1 is the loss factor.

In one embodiment the spike filtration unit 410 may filter a speech data frame with at least one detected spike based upon speech data of a preceding frame and speech data of a succeeding frame. Further the spike filtration unit 410, may output frames without detected spikes unfiltered.

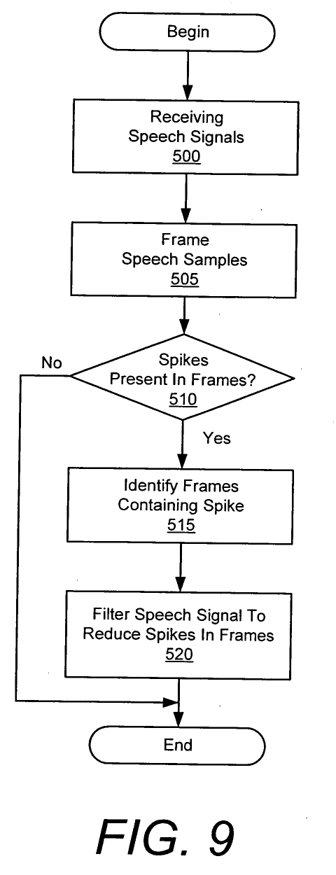

Reference is now made to FIG. 9 which depicts an embodiment of detecting and filtering spikes of as speech signal and may be implemented by the communication system of FIG. 6. As depicted, in block 500 the IEU 305 may receive the speech signals from telephony interface 200 of a voice channel 1. The telephony interface 200 may receive the speech signals from the user's instrument (not shown).

In block 505, the IEU 305 upon receiving the speech signals from the telephony interface 200 may start framing samples of the received speech signal for processing. In particular, the spike detection unit 407 or processor 307 may allocate samples of the speech signals to data frames for processing. According to an embodiment a set of speech samples may be allocated to more than one frame. Thus, for example a first frame of speech samples may include speech samples sampled at time 1 to time 10, a second frame of speech samples may include speech samples sampled from time 6 to time 15, and a third frame of speech samples may include speech samples sampled from time 11 to time 20. Thus, in one embodiment up to 50% speech signal samples may be allocated in the neighboring speech signals data frames. It should be appreciated that other framing techniques may be utilized by the IEU 305.

In block 510, the spikes may be detected by monitoring the speech data frames and by comparing the characteristics of the speech signals present in the speech data frames with the characteristics of the speech signals present in the neighboring speech data frames. The IEU 305 according to an embodiment may detect presence of spikes in a frame of speech data when the RMS value in the frame is greater than a predetermined value and the ZCR value in the frame is less than a predetermined value. The predetermined values may be set such that type X spikes are determined when a high RMS value and a low ZCR value are present. If spikes are not detected in a speech data frame, such speech data frame may be conveyed to a speech encoder 310 without filtering the frame through the IEU 305.

In block 515, the IEU 305 may detect the position of detected spikes. In one embodiment, the spike detection unit 407 may provide the spike filtering unit 408 with the position of detected spikes in the speech signal. In particular, the spike detection unit 407 may identify which frames of the speech signal have detected spikes.

In block 520, the IEU 305 may further process the speech signal data frames in order to filter the spikes from the speech signal data frames. In one embodiment, the spike filtering unit 408 may filter identified speech data frames on the basis of the principle of interpolation to regenerate the speech frames having reduced spikes, before conveying the speech signals to the speech encoder 310 to reduce the spikes in the speech signal. For example the spike filtering unit 408 may filter the speech signals so as to reconstruct speech signals and/or regenerate speech signals data frames with reduced spikes by interpolating speech signals from neighboring frames. The encoder 310 may encode the spike reduced speech signals and convey the signals to be transmitted. The signals so transmitted may be received by a decoder 410 provided with the codec at the other end of the network.

Certain features of the invention have been described with reference to example embodiments. However, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. A method comprising
framing speech data into a plurality of frames,
identifying a frame that has a detected spike, and
filtering the identified frame with the detected spike using speech data of other frames of the plurality of frames.

2. The method of claim 1 wherein framing comprises allocating the speech data to the plurality of frames such that at least a portion of the speech data is allocated to more than one frame of the plurality frames.

3. The method of claim 1 wherein framing comprises allocating the speech data such that each frame of the plurality of frames comprises up to 50% of speech data allocated to a previous frame of the plurality of frames.

4. The method of claim 1 wherein identifying comprises comparing characteristics of the frame to characteristics of neighboring frames to detect presence of spikes in the frame.

5. The method of claim 1 wherein identifying comprises detecting spike presence based upon zero crossing rates of the plurality of frames.

6. The method of claim 1 wherein identifying comprises detecting spike presence based upon root mean square values of the plurality of frames.

7. The method of claim 1 wherein identifying comprises detecting spike presence based upon sample energy values of the plurality of frames.

8. The method of claim 1 wherein filtering comprises regenerating the identified frame from other frames of the plurality of frames to reduce the detected spike in the identified frame.

9. The method of claim 1 wherein filtering comprises replacing the identified frame with a replacement frame generated by averaging neighboring frames of the identified frame to reduce spikes in the replacement frame.

10. The method of claim 9 further comprising encoding the plurality of frames using a speech encoder after filtering the plurality of frames.

11. An apparatus comprising
a telephony interface to receive speech signal,
an interference excision unit to frame samples of the speech signal into a plurality of frames, to detect spikes in frames of the plurality of frames, and to filter frames with detected spikes using speech data of neighboring frames, and
a speech encoder to encode the samples of the plurality of frames generated by the interference excision unit.

12. The apparatus of claim 11 wherein the interference excision unit allocates samples of the speech signal to the plurality of frames such that at least a portion of the samples is allocated to more than one frame of the plurality frames.

13. The apparatus of claim 11 wherein the interference excision unit allocates samples of the speech signal such that each frame of the plurality of frames comprises up to 50% of samples allocated to a previous frame of the plurality of frames.

14. The apparatus of claim 11 wherein interference excision unit detects spikes by comparing characteristics of each frame to characteristics of neighboring frames.

15. The apparatus of claim 11 wherein the interference excision unit filters a frame of the plurality of frames by regenerating the frame from other frames of the plurality of frames to reduce spikes in the frame.

16. The apparatus of claim 11 wherein the interference excision unit filters a frame of the plurality of frames by replacing the frame with a replacement frame generated by averaging neighboring frames of the frame to reduce spikes in the replacement frame.

17. The apparatus of claim 11 wherein the interference excision unit passes frames without detected spikes to the encoder unfiltered.

18. A machine-readable medium comprising a plurality of instructions that, in response to being executed, results in computing device
generating a plurality of frames from samples of a speech signal,
comparing characteristics of each frame to characteristics of neighboring frames to detect spikes in the each frame, and
filtering frames identified with at least one detected spike using samples of other frames of the plurality of frames.

19. The machine-readable medium of claim 18 wherein the plurality of instructions further result in the computing device overlapping frames of the plurality of frames such that at least some samples of the speech signal are allocated to more than one frame of the plurality frames.

20. The machine-readable medium of claim 18 wherein the plurality of instructions further result in the computing device overlapping frames of the plurality of frames such that each frame of the plurality of frames comprises up to 50% of speech samples allocated to a previous frame of the plurality of frames.

21. The machine-readable medium of claim 18 wherein the plurality of instructions further result in the computing device filtering a frame identified having at least one spike by regenerating the frame from other frames of the plurality of frames to reduce spikes in the frame.

22. The machine-readable medium of claim 18 wherein the plurality of instructions further result in the computing device filtering a frame identified having at least one spike by replacing the frame with an average of neighboring frames of the frame to reduce spikes in the frame.

23. An apparatus comprising
a spike detection unit to frame data of a speech signal into a plurality of frames and to detect spikes in frames of the plurality of frames, and
a spike filtration unit to filter a frame with at least one detected spike based upon speech data of a preceding frame and speech data of a succeeding frame.

24. The apparatus of claim 23 wherein the spike detection unit allocates data to the plurality of frames such that at least a portion of the data is allocated to more than one frame of the plurality frames.

25. The apparatus of claim 23 wherein the spike detection unit detects spikes by comparing characteristics of each frame to characteristics of a preceding frame and to characteristics of a succeeding frame.

26. The apparatus of claim 23 wherein the spike filtration unit filters a frame of the plurality of frames by regenerating the frame from other frames of the plurality of frames to reduce spikes in the frame.

27. The apparatus of claim 23 wherein the spike filtration unit filters a frame of the plurality of frames by replacing the frame with an average of a preceding frame and a succeeding frame.

28. The apparatus of claim 23 wherein the spike filtration unit outputs frames without detected spikes unfiltered.
